(19) United States
(12) Patent Application Publication
(10) Pub. No.: US 2024/0417023 A1
(43) Pub. Date: Dec. 19, 2024

(54) SHOCK-ABSORBING STEM TUBE

(71) Applicant: HSIN LUNG ACCESSORIES CO., LTD., Hsin-Chu Hsien (TW)

(72) Inventor: Hsueh-Sen LIAO, Hsin-Chu Hsien (TW)

(21) Appl. No.: 18/733,098

(22) Filed: Jun. 4, 2024

(30) Foreign Application Priority Data
Jun. 13, 2023 (TW) 112205977

(51) Int. Cl. B62K 21/14

(52) U.S. Cl. CPC B62K 21/14

(57) ABSTRACT

The invention is adapted for use with a bicycle, where a handlebar is connected to a front fork tube through a stem tube having a stem seat and a handlebar seat. A pair of lug clip portions and a pivotal portion are provided between the stem seat and the handlebar seat and pivotally connected to each other through a pivotal assembly. At least one abutting portion is formed beneath the pivotal portion, and a shock-absorbing member is mounted beneath the at least one abutting portion. The pivotal assembly is provided atop with a press block which is secured to and tightly abuts against the pivotal assembly using a first fastening member. The press block is provided at its upper surface with an accessory fixation structure adapted for coupling an accessory to the stem tube. The accessory fixation structure enables rapid installation of accessories onto the stem tube.

### PRIORITY CLAIM

This application claims priority to R.O.C. Utility Model application No. 112205977 filed Jun. 13, 2023, the entirety of which is incorporated herein by reference.

### BACKGROUND OF THE INVENTION

### 1. Field of the Invention

The present invention generally relates to a shock-absorbing stem tube that is adapted for use in a bicycle, and more particularly to a shock-absorbing stem tube with shock-absorbing functionality that enhances riding comfort.

### 2. Description of Related Art

Bicycles are a commonly used means of transportation. Their power source comes from pedaling by human force and does not need electricity or gasoline, making them very environmentally friendly and suitable for serving as a general tool of transportation or a leisure sports equipment. Since riding bicycles has been promoted for its recreation and environmental benefits, more and more people are selecting it for transportation. In general, a bicycle handlebar is used to control the direction of travel, and the handle grip is connected to the front fork tube of the bicycle by a stem tube, so that the bicycle rider can control the rotation of the front fork tube by turning the handlebar, thereby changing the direction of travel of a bicycle.

However, a conventional bicycle stem tube has only the function of connecting the handlebar and the front fork tube. However, there is rarely a completely flat road. Therefore, when a user rides a bicycle and encounters rugged roads or climbs on a stone road where there are high or low slopes on the road surface, the bicycle will vibrate due to the unevenness of the ground. The vibration on the front wheel is easily transmitted to the handlebar via the front fork tube and the stem tube. In a less serious situation, such a vibration will affect the rider's comfort in gripping the handlebar. Long time of riding is likely to cause tingling discomfort of two hands. In a more serious situation, it will hamper the rider's handling of the bicycle and affect the safety of the bicycle as it travels.

However, in the case of employing, for example, a swing arm-type mechanism to improve the comfort of hands during riding, the stem tube is mainly divided into pivotally connected upper and lower portions with an elastic member being sandwiched therebetween. Therefore, when the stem tube experiences shocks, the vibration force is directly perceived through the mobility of the upper stem portion and immediately absorbed by the elastic member, thereby reducing the occurrence of severe handlebar vibrations.

It can easily note that the conventional mechanism described above has some drawbacks. Specifically, the upper stem portion is formed at its end with a pivot hole for connection to the lower stem portion. The upper stem portion leaves a part of its side beneath the cap slot for abutting. The lower stem portion is arranged opposite to the upper stem portion and provided at one end with a socket seat corresponding to the front fork. The other end of the lower stem portion extends forwards and is formed with a recessed groove. The lower stem portion protrudes a limiting edge at its very front end and is formed with a pivot hole corresponding to the pivot hole of the upper stem portion. In the assembly process, the elastic member is placed in the recessed groove, the abutting side of the upper stem portion is placed beneath the limiting edge, and then it is brought down while compressing the elastic member to facilitate assembly, such that the pivot holes formed on the upper and lower stem portions are aligned, through which a pivot pin can be inserted.

As described above, the conventional swing arm-type bicycle handlebar shock-absorbing device includes a high number of constitutive components and a complex assembly, resulting in a bulky overall structure. The handle shock-absorbing part is prominent, which not only increases the overall weight but also makes assembly time-consuming and raises production and manufacturing costs. It cannot meet the modern demands for simplicity and lightweight bicycle design, which, in turn, reduces the willingness of riders to purchase the product.

### SUMMARY OF THE INVENTION

In view of this, the present invention provides a shock-absorbing stem tube that is suitable for use in bicycles, and more particularly to a shock-absorbing stem tube that is capable of damping shock impulses and improving riding comfort.

The invention is adapted for use with a bicycle, where a handlebar is connected to a front fork tube through a stem tube comprising a stem seat and a handlebar seat. A pair of lug clip portions and a pivotal portion are provided between the stem seat and the handlebar seat and pivotally connected to each other through a pivotal assembly. The pivotal portion is formed with a first axle hole, within which the pivotal assembly is sleeved to establish the pivotal connection to the lug clip portions. At least one abutting portion is formed beneath the first axle hole, and a shock-absorbing member is mounted beneath the at least one abutting portion and fixed on the stem seat and/or the handlebar seat. The pivotal assembly is provided atop with a press block which is secured to and tightly abuts against the pivotal assembly using a first fastening member. The press block is provided at its upper surface with an accessory fixation structure which is adapted for coupling an accessory to the stem tube. The accessory fixation structure has at least one recessed portion formed on the upper surface of the press block, a connector conforming in shape to the recessed portion and adapted for connection to the accessory, and a second fastening member. The recessed portion is formed with at least one fixing hole, into which the second fastening member may be inserted to secure the connector.

The accessory fixation structure herein enables rapid installation of accessories onto the stem tube. When a rider is riding a bicycle on an uneven road causing the front fork tube to shake and move up and down, the invention disclosed herein can buffer and absorb the shock force as the pressing portion presses against the shock absorbing member to reduce the discomfort of the hands due to the shaking of the bicycle, thus improving the comfort and safety of bicycle riding and significantly stabilizing the accessory installed on the stem tube. The shock-absorbing member herein is directly mounted on the stem seat and/or the handlebar seat, which has simplified structural arrangement and can be assembled easily.

### BRIEF DESCRIPTION OF THE DRAWINGS

The above and other objects, features and effects of the invention will become apparent with reference to the following description of the preferred embodiments taken in conjunction with the accompanying drawings, in which:

FIG. 1 is a perspective structural diagram of the shock-absorbing stem tube according to the invention;

FIG. 2 is an exploded structural diagram of the shock-absorbing stem tube according to the invention;

FIG. 3 is a schematic structural view of the shock-absorbing stem tube according to the invention;

FIG. 4 is another schematic structural view of the shock-absorbing stem tube according to the invention; and

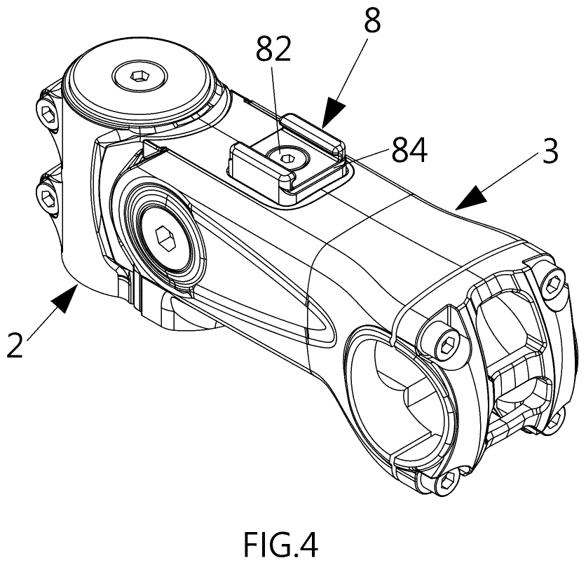

FIG. 5 is an enlarged schematic structural diagram of the shock-absorbing stem tube according to the invention in combination with an accessory.

### DETAILED DESCRIPTION OF THE INVENTION

In order to facilitate the examiner's understanding of the technical features, content and advantages of the invention and the efficacies it can achieve, the invention will be described in detail as follows in the form of embodiments and with reference to the accompanying drawings. The drawings used herein are merely for the purpose of illustration and supplement for the invention, and may not be the true proportions and precise configurations after the invention is implemented. Therefore, relationships between the proportions and configurations of the attached drawings should not be used to interpret or limit the scope of claims in the actual implementation.

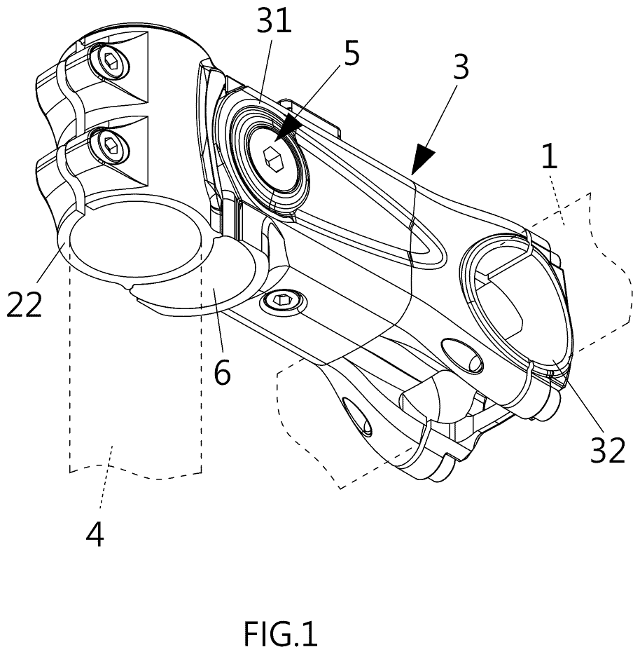

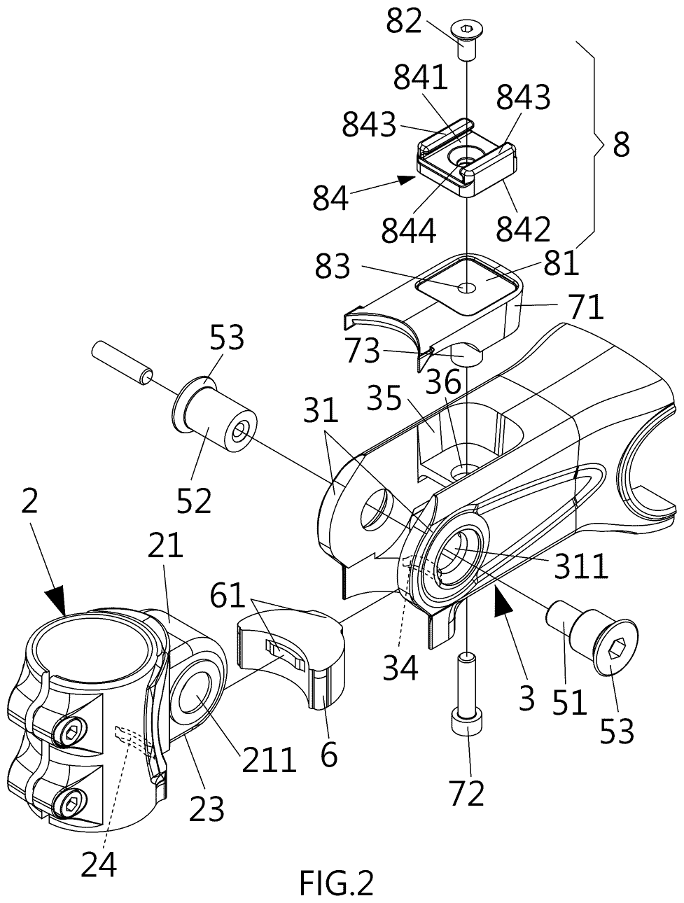

FIG. 1 is a perspective structural diagram of the shock-absorbing stem tube according to the invention, and FIG. 2 is an exploded structural diagram of the shock-absorbing stem tube according to the invention. As disclosed herein, a bicycle handlebar 1 is connected to a front fork tube 4 through a stem tube, while the stem tube comprises a stem seat 2 and a handlebar seat 3. The bottom of the front fork tube 4 is adapted for connection to a front wheel (not shown) of the bicycle. The stem seat 2 is integrally provided with a pivotal portion 21 and a sleeve portion 22. The sleeve portion 22 is adapted for being sleeved on top of the front fork tube 4. The handlebar seat 3 is integrally provided with a pair of lug clip portions 31 and a socket portion 32. The socket portion 32 is adapted for being sleeved to the handlebar 1 of the bicycle, while the pair of lug clip portions 31 are pivotally connected to the pivotal portion 21 by a pivotal assembly 5, thereby forming a connection between the handlebar 1 and the front fork tube 4.

A gist of the invention is that the pivotal portion 21 is formed with a first axle hole 211 for the pivotal assembly 5 to be sleeved inside to establish a pivotal connection to the lug clip portions 31. At least one abutting portion 23 is formed beneath the first axle hole 211, whereas a shock-absorbing member 6 is mounted beneath the at least one abutting portion 23. The shock-absorbing member 6 is fixed on the stem seat 2 and/or the handlebar seat 3. The shock-absorbing member 6 may be made from an elastic material, such as plastic, rubber, or configured in form of a spring.

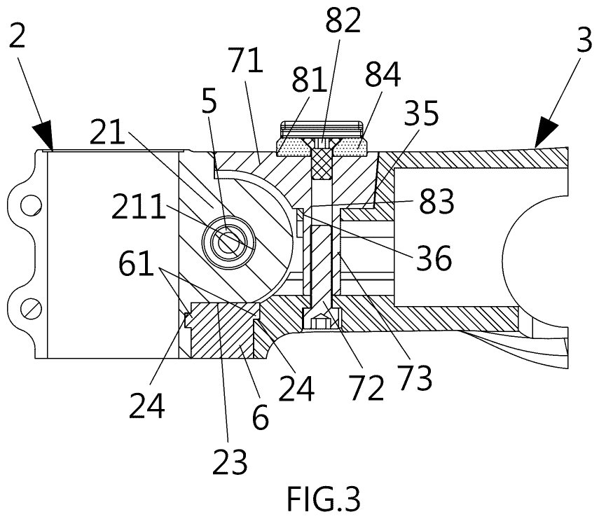

In the embodiment shown in the drawings, a snap-in mechanism may be provided between the shock-absorbing member 6 and the stem seat 2 to help secure the shock-absorbing member 6 to the stem seat 2. Another snap-in mechanism may be provided between the shock-absorbing member 6 and the handlebar seat 3, so as to keep the shock-absorbing member 6 fixed to the handlebar seat 3. The snap-in mechanism may comprise at least one protrusion 61 located on the shock-absorbing member 6, a groove 24 on the stem seat 2 and a groove 34 on the handlebar seat 3. As shown in FIG. 3, the protrusions 61 are snapped into the corresponding grooves 24, 34, so that the shock-absorbing member 6 is secured between the stem seat 2 and the handlebar seat 3. It is apparent to those skilled in the art that the protrusions may alternatively be provided on the stem seat and the handlebar seat, with the grooves being formed on the shock-absorbing member, achieving the same interlocking and securing effect.

During the assembly process, the shock-absorbing member 6 is secured to the stem seat 2 by snaping the protrusion 61 into the groove 24 and placed under the abutting portion 23. Next, the other protrusion 61 is snaped into the groove 34 on the handlebar seat 3, and the pivotal portion 21 is aligned with the pair of lug clip portions 31, each being formed with a second axle hole 311 that corresponds to the first axle hole 211. The pivotal assembly 5 is then inserted into the pivot portion 21 and the lug clip portions 31. The pivotal assembly 5 comprises first and second tightening members 51, 52 that can be engaged with each other and secured together. The first and second tightening members 51, 52 are provided at their outer ends with a cover plate 53 conforming in shape to the lug clip portions 31. By inserting the first and second tightening members 51, 52 into the first and second axle holes 211, 311 and engaging the two tightening members with each other, the stem seat 2 and the handlebar seat 3 are combined pivotally, creating a connection between the handle 1 and the front fork tube 4.

Furthermore, the pivotal assembly 5 is provided atop with a press block 71 which is secured to and tightly abuts against the pivotal assembly 5 using a first fastening member 72. According to the embodiment shown in the drawings, the handlebar seat 3 is formed with an accommodation recess 35 facing towards the gap between the lug clip portions 31, into which the press block 71 may be placed. The first fastening member 72 is inserted through the handlebar seat 3 from beneath and fastened inside the press block 71. The first fastening member 72 may be configured in form of a screw adapted for being tightened into the press block 71 to eliminate any gap between the press block 71 and the pivotal assembly 5, ensuring that the abutting portion 23 located beneath the first axis hole 211 can effectively abut downwardly against shock-absorbing member 6.

When a rider is riding a bicycle to an unevenness road, causing the bicycle to shake, the handlebar seat 3 will be shaken as the front fork tube 4 sleeved within the sleeve portion 22 of the stem seat 2 vibrates up and down. At this time, the abutting portion 23 will press against the shock-absorbing member 6, allowing the shock-absorbing member 6 to absorb the vibration of the front fork tube 4 to reduce the intensity of shaking of the handlebar seat 3, and the handlebar 1 sleeved on the handlebar seat 3 will not generate vibration or only generate slight shock, effectively reducing the discomfort caused by the bicycle vibration.

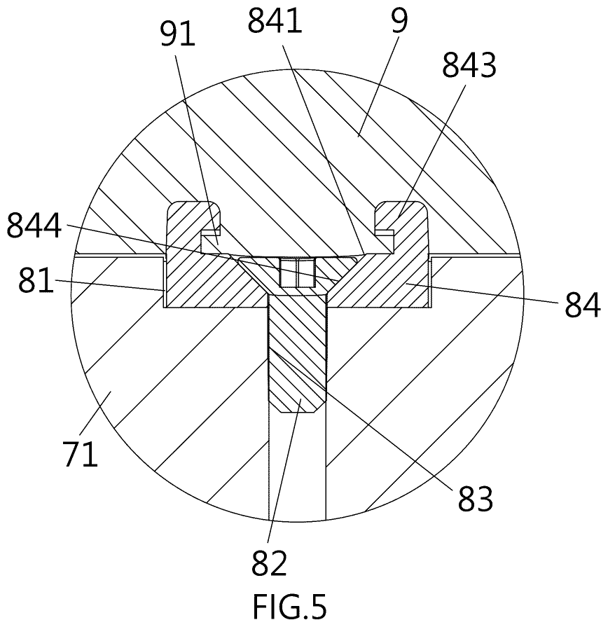

Another gist of the invention is that the press block 71 is provided at its upper surface with an accessory fixation structure 8 which is adapted for coupling an accessory (not shown) to the stem tube. The accessory fixation structure 8 has at least one recessed portion 81 formed on the upper surface of the press block 71, and a second fastening member 82. The press block 71 is formed with at least one fixing hole 83 connecting its upper and lower surfaces, into which the second fastening member 82 may be inserted to secure the connector. In this embodiment, the accessory fixation structure 8 further includes a connector 84 conforming in shape to the configuration of the recessed portion 81. The recessed portion 81 and the connector 84 are configured in non-circular shape, such as in polygonal shape, thus preventing the connector 84 from rotating within the recessed portion 81. While the recessed portion 81 and the connector 84 are both configured in quadrilateral shape according to the embodiment shown in the drawings, their shapes may vary in other applications. As shown in FIG. 5, the connector 84 includes a mount surface 841 for receiving the accessory 9, and a bottom surface 842 opposite to the mount surface 841. The mount surface 841 is formed with at least one protruding snap-in portion 843, and the connector 84 is positioned with its bottom surface 842 facing the recessed portion 81 so that the second fastening member 82 may releasably secure the connector 84 to the recessed portion 81. The second fastening member 82 may be configured in form of a bolt, and the fixing hole 83 may be threaded internally. The connector 84 may be formed with a through-hole 844, through which the second fastening member 82 may penetrate and be secured in the fixing hole 83.

The press block 71 is provided at its lower surface with a positioning pillar 73. The fixing hole 83 is a through hole penetrating from the recessed portion 81 located on the upper surface of the press block 71 to the positioning pillar 73. The accommodation recess 35 is formed with a positioning hole 36 for receiving and positioning the positioning pillar 73, thus positioning the press block 71 onto the handlebar seat 3.

According to the embodiment shown in the drawings, the mount surface 841 may be provided with two snap-in portions 843, which are oppositely arranged and extend upwards from two opposite sides of the mount surface 841. The invention utilizes the recessed portion 81 to preposition the connector 84 on the upper surface of the press block 71, so that the connector 84 may be secured to the upper surface of the press block 71 with the second fastening member 82. This structural arrangement allows for simple assembly of the accessory fixation structure herein. In use, since the accessory 9 is formed with a slot 91, and the mount surface 841 has two snap-in portions 843, the two snap-in portions 843 may be inserted into and engaged with the slot 91 in a detachable manner. In this way, users can conveniently and quickly attach the accessory 9 to the press block 71 through the connector 84 or detach the accessory 9 from the press block 71, thus achieving rapid assembly on the stem tube.

The accessory fixation structure herein enables rapid installation of accessories onto the stem tube. When the user is riding, the vibrations are buffered and absorbed due to the structural arrangement of the abutting portion 23 pressing against the shock-absorbing member 6, thus achieving an enhanced shock-absorbing effect and a significantly improved stability of accessory installation on the stem tube.

In summary, the invention provides an improved and feasible shock-absorbing stem tube. While the invention has been described with reference to the preferred embodiments above, it should be recognized that the preferred embodiments are given for the purpose of illustration only and are not intended to limit the scope of the invention and that various modifications and changes, which will be apparent to those skilled in the relevant art, may be made without departing from the spirit and scope of the invention.

I claim:

1. A shock-absorbing stem tube, through which a bicycle handlebar is adapted for connection to a front fork tube, the stem tube comprising a stem seat and a handlebar seat, between which a pair of lug clip portions are pivotally connected to a pivotal portion through a pivotal assembly, the stem tube further comprising:
the pivotal portion is formed with a first axle hole, within which the pivotal assembly is sleeved to establish the pivotal connection to the lug clip portions, and at least one abutting portion is formed beneath the first axle hole, and a shock-absorbing member is mounted beneath the at least one abutting portion and fixed on the stem seat.

2. The shock-absorbing stem tube according to claim 1, further comprising a snap-in mechanism provided between the shock-absorbing member and the stem seat to secure the shock-absorbing member to the stem seat, wherein the snap-in mechanism comprises at least one protrusion and grooves corresponding thereto.

3. The shock-absorbing stem tube according to claim 1, wherein the pivotal assembly is provided atop with a press block which is secured to and tightly abuts against the pivotal assembly using a first fastening member.

4. The shock-absorbing stem tube according to claim 3, wherein the first fastening member is inserted through the handlebar seat and fastened inside the press block.

5. The shock-absorbing stem tube according to claim 3, wherein the press block is provided at its upper surface with an accessory fixation structure which is adapted for coupling an accessory to the stem tube, and wherein the accessory fixation structure has at least one recessed portion formed on the upper surface of the press block, a connector conforming in shape to the recessed portion and adapted for connection to the accessory, and a second fastening member, and wherein the recessed portion is formed with at least one fixing hole, into which the second fastening member may be inserted to secure the connector.

6. The shock-absorbing stem tube according to claim 5, wherein the connector comprises a mount surface for receiving the accessory and a bottom surface opposite to the mount surface, and wherein the mount surface is provided with at least one protruding snap-in portion, so that the second fastening member may releasably secure the connector to the recessed portion.

7. The shock-absorbing stem tube according to claim 6, wherein the mount surface is provided with two oppositely arranged snap-in portions.

8. A shock-absorbing stem tube, through which a bicycle handlebar is adapted for connection to a front fork tube, the stem tube comprising a stem seat and a handlebar seat, between which a pair of lug clip portions are pivotally connected to a pivotal portion through a pivotal assembly, the stem tube further comprising:
the pivotal portion is formed with a first axle hole, within which the pivotal assembly is sleeved to establish the pivotal connection to the lug clip portions, and at least one abutting portion is formed beneath the first axle hole, and a shock-absorbing member is mounted beneath the at least one abutting portion and fixed on the handlebar seat.

9. The shock-absorbing stem tube according to claim 8, further comprising a snap-in mechanism provided between the shock-absorbing member and the handlebar seat to secure the shock-absorbing member to the handlebar seat, wherein the snap-in mechanism comprises at least one protrusion and grooves corresponding thereto.

10. The shock-absorbing stem tube according to claim 8, wherein the pivotal assembly is provided atop with a press block which is secured to and tightly abuts against the pivotal assembly using a first fastening member.

11. The shock-absorbing stem tube according to claim 10, wherein the first fastening member is inserted through the handlebar seat and fastened inside the press block.

12. The shock-absorbing stem tube according to claim 10, wherein the press block is provided at its upper surface with an accessory fixation structure which is adapted for coupling an accessory to the stem tube, and wherein the accessory fixation structure has at least one recessed portion formed on the upper surface of the press block, a connector conforming in shape to the recessed portion and adapted for connection to the accessory, and a second fastening member, and wherein the recessed portion is formed with at least one fixing hole, into which the second fastening member may be inserted to secure the connector.

13. The shock-absorbing stem tube according to claim 12, wherein the connector comprises a mount surface for receiving the accessory and a bottom surface opposite to the mount surface, and wherein the mount surface is provided with at least one protruding snap-in portion, so that the second fastening member may releasably secure the connector to the recessed portion.

14. The shock-absorbing stem tube according to claim 12, wherein the mount surface is provided with two oppositely arranged snap-in portions.
